(19) United States
(12) Patent Application Publication
(10) Pub. No.: US 2012/0001999 A1
(43) Pub. Date: Jan. 5, 2012

(54) APPARATUS AND METHOD FOR CHANGING A CAMERA CONFIGURATION IN RESPONSE TO SWITCHING BETWEEN MODES OF OPERATION

(75) Inventors: Jochen Christof SCHIRDEWAHN, Stabekk (NO); Simen Andresen, Eiksmarka (NO)

(73) Assignee: TANDBERG TELECOM AS, Lysaker (NO)

(21) Appl. No.: 12/829,176

(22) Filed: Jul. 1, 2010

(51) Int. Cl. H04N 7/15

(52) U.S. Cl. 348/14.01; 348/E07.083

(57) ABSTRACT

A videoconferencing terminal and method use a display and camera that are adaptable depending on the mode of operation: videoconference mode, or document camera mode. The camera is pivotally mounted on the display, and is pivotally positionable within different pivot ranges according to the pivot angle with respect to a surface on which the display is positioned. When the camera is rotated beyond a predetermined non-zero angle relative to a vertical plane, the mode of operation automatically switches to a document pick-up mode of operation. In the document pick-up mode, the image of the document is flipped so as to be viewed by users at both endpoints of a videoconference call. Also, the camera is set to maximum zoom and focus adjusted to a predetermined distance so as to make for a clean image capture of the document. Also, the camera provides for keystone correction due to the lens not being co-planer with the document.

### FIELD OF THE INVENTION

The present invention relates to a desktop video conferencing terminal, and more specifically to a desktop video conferencing terminal and method for switchably operating between a normal videoconferencing mode and in a document camera mode.

### BACKGROUND

Conventional video conferencing systems include a number of terminals communicating real-time video, audio and/or data (often referred to as duo video) streams over and between various networks, such as packet switched networks and circuit switched networks.

Video conferencing terminals typically include a camera, a microphone, a loudspeaker and a screen. The audio stream and video stream from the microphone and camera respectively, is compressed and sent to one or more receiving sites in the video conference. All sites in the conference receive live video and audio from the other sites in the conference, thus enabling real time communication with both visual and acoustic information.

During a video conference, participants at a local site often wish to share certain visual details of physical objects with the remote site. A typical example of this is a participant who wants to share information only accessible on paper, e.g. images, diagrams, drawings or even text. Traditionally, external devices such as standalone document cameras are used to share non-electronic content, such as documents, objects, etc. The standalone document cameras are sold separately and are usually connected to the video conferencing terminal via some sort of wired connection. The standalone document cameras are expensive and space demanding. FIG. 1 shows a typical standalone document camera.

Japanese Patent Application No. 5-167899A proposes a video telephone having a camera adapted to be used for picking up a person and a document/object. FIGS. 2a and 2b are perspective views illustrating this conventional video telephone having a monitor part 111 and a camera part 112. FIG. 2a shows the video telephone set for picking up a person's voice and image, while FIG. 2b shows the video telephone set for picking up a document. The video telephone in JP 5-167899 is advantageous in that a person and a document cam be picked up by a single camera. However, as recognized by the present inventor, the horizontal pick-up range is limited to a pick-up viewing angle inherent to the lens of the camera, and accordingly, it is unlikely that the viewing angle of the camera lens is optimal for both picking up a person in front of the video telephone and for picking up a document on the desktop. Further, using the video telephone in JP 5-167899A, the user has little or no control over what the receiving party is viewing when the video telephone is picking up a document.

U.S. Pat. No. 5,734,414 discloses a camera unit adapted to be set on a monitor of a large room video conference system. The camera unit in U.S. Pat. No. 5,734,414 includes several motors and gears, and is hence unsuitable for a desktop video conference terminal, especially a flat panel display. Further, as with the the video telephone in JP 5-167899A, the user has little or no control over what the receiving party is viewing when the video telephone is picking up a document.

### SUMMARY

A videoconferencing terminal having a display and camera are adaptable depending on the mode of operation: videoconference mode, or document camera mode. The camera is pivotally mounted on the display, and is pivotally positionable within different pivot ranges according to the pivot angle with respect to a surface on which the display is positioned.

When the camera is rotated beyond a predetermined non-zero angle relative to a vertical plane, the mode of operation automatically switches to a document pick-up mode of operation. In the document pick-up mode, the image of the document is flipped so as to be viewed by users at both endpoints of a videoconference call. Also, the camera is set to maximum zoom and focus adjusted to a predetermined distance so as to make for a clean image capture of the document. Also, the camera provides for keystone correction due to the lens not being co-planer with the document.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an image of a conventional document camera,

FIGS. 2a and 2b are perspective images of a conventional video telephone,

FIG. 3 is a perspective view illustrating the desktop video conference terminal according to one embodiment of the invention,

FIG. 4 is a schematic overview a desktop video conferencing terminal according to certain teachings of the present invention,

FIG. 5 is a block diagram illustrating the tilt angle of a camera,

FIGS. 6a and 6b is a perspective view illustrating the desktop video conference terminal according to one embodiment of the invention,

FIG. 7 is a flow chart illustrating principles of a method according to certain teachings of the present invention,

FIG. 8 is a flowchart showing a process flow for determining how to perform image processing and onscreen display when in a document mode and in an overlay mode of operation according to an embodiment of the present invention, and

FIG. 9 is an image showing an overlay or imitation mode according to embodiment of the present invention.

### DETAILED DESCRIPTION

In the following, the present invention will be discussed by describing various embodiments, and by referring to the accompanying drawings. However, people skilled in the art will realize other applications and modifications within the scope of the invention as defined in the enclosed independent claims.

The present invention relates to a desktop video conferencing terminal having a camera tiltably associated with the terminal, and where the terminal is configured to operate in normal mode (person pick-up mode) and in a document camera mode, depending on camera tilt position. In document camera mode, the terminal modifies the images picked up by the camera by at least rotating the images 180 degrees. The modified images are displayed on the display of the desktop terminal and sent to remote sites.

FIG. 3 is an illustration of a desktop video conferencing terminal 100 according to certain teachings of the present disclosure. The videoconferencing terminal 100 has a main body 110 and a camera 170. The main body 110 includes at least a display 120 for displaying images. According to one exemplary embodiment, the main body further includes a videoconferencing unit 130 (not shown), one or more speakers and one or more microphone. However, the videoconferencing unit 130, the one or more speakers and the one or more microphones may also be peripheral devices, such that the main body is only used to display images output from the videoconferencing unit 130 and to support the camera 170 and a tilt mechanism for the camera. In one embodiment, the desktop terminal 100 is a TANDBERG EX90, a product of the Assignee of the present disclosure.

The videoconferencing unit 130 is used to establish and conduct a videoconference with remote endpoints (not shown) via a network, such as packet switched or circuit switched networks. The videoconferencing unit 130 is connected to the camera, the display 120, one or more speakers (not shown), and one or more microphones (not shown). The video conferencing unit 130 is discussed in more detail below.

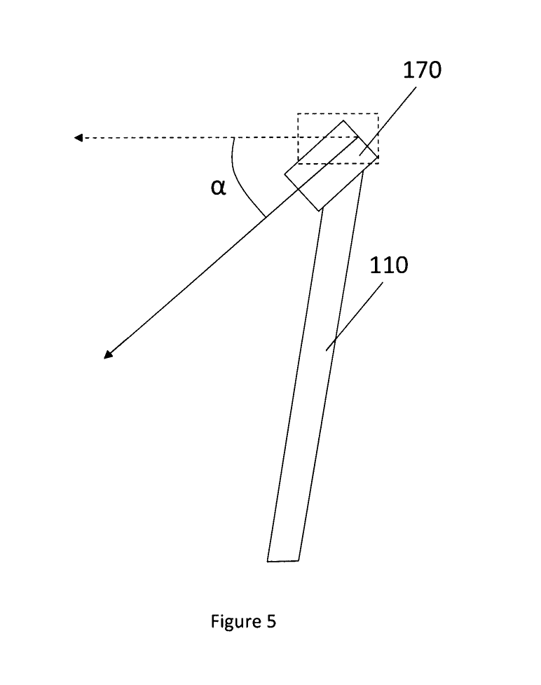

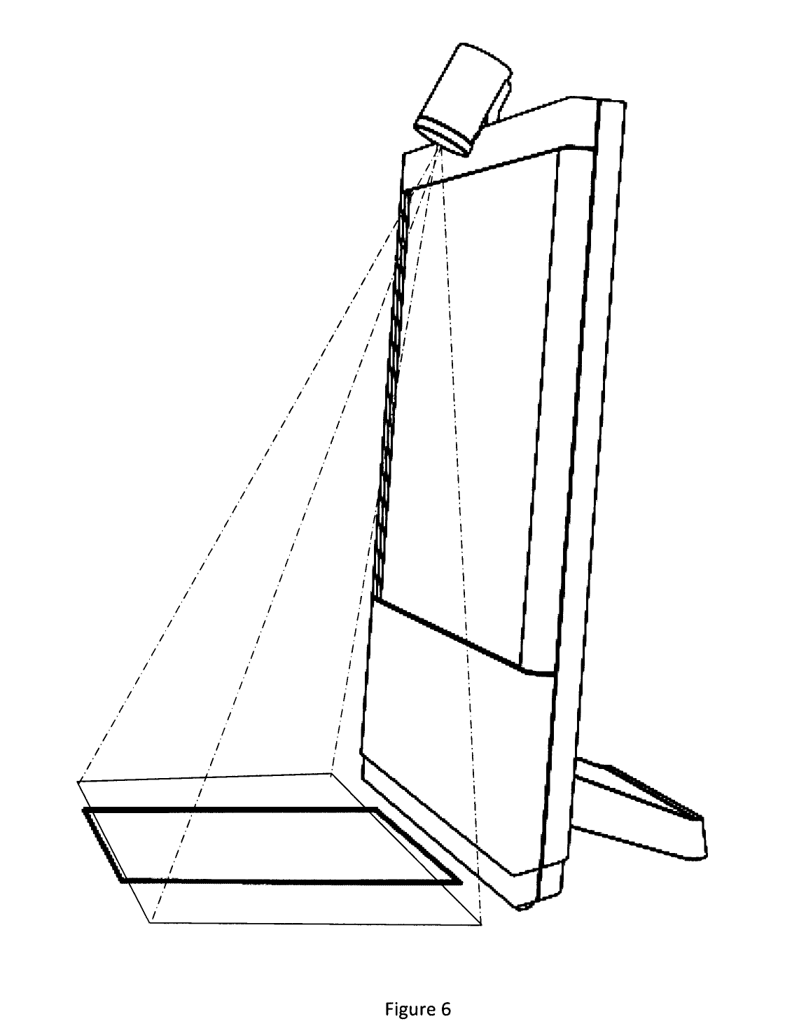

The camera 170 includes a camera housing, a lens system and an image sensor, such as CCD, CMOS, etc. The camera 170 is tiltably associated with the main body 110 via a tilt mechanism 172, such that the camera may be tilted downwards from a start position to an end position. In the start position, the camera 170 is oriented forward, such that it captures at least parts of a person sitting on a chair in front of the desktop system. At the other end of the camera's rotational dynamic range, the camera is oriented downwards such that the camera captures at least parts of a document placed on a desk in front of the desktop system (see FIG. 5a-5b). According to one exemplary embodiment, the optical axis of the cameras lens system is substantially parallel with the desktop surface (on which the main body sits) when the camera is in the start position. Further the camera may be tilted downwards 65-90 degrees with respect to the start position. The tilt mechanism 172 holds the camera firmly in all positions between the start position and the end position. According to one embodiment, the tilt mechanism is a friction joint, where the user may freely change the tilt angle of the camera using his/her hands.

According to another embodiment of the present invention the tilt mechanisms 172 includes an electric motor and/or gears that can be controlled by the user via a user interface.

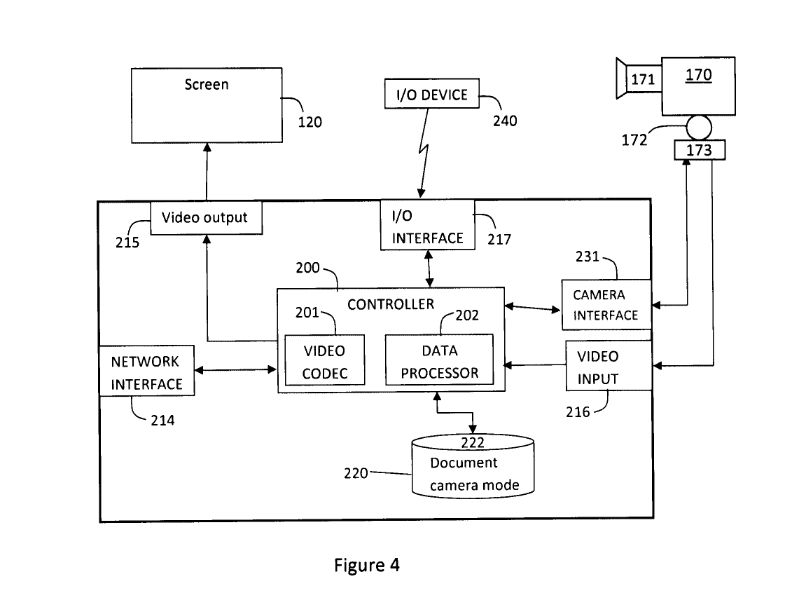

Referring now to FIG. 4, the videoconferencing unit 130 according to the present invention is schematically illustrated in more detail. The videoconferencing unit 10 has a controller 200, which can include any conventional decoders/encoders, processors, and other electronic components known in the art and used for a videoconferencing unit. The controller 200 is coupled to an output 215 for video, an I/O interface 217 for user interface, and a memory 220 for storing instructions/functions. The controller 200 is also coupled to an input 216 for receiving video from a local camera 170, and optionally an interface 231 (the input 216 and interface 231 may be combined in a single interface, such as a USB 2.0 interface, for example) for controlling the local camera 170. and exchange commands and rotation detection settings with the controller 200. The video output 215 is coupled to a video input of the display 120, and optionally an I/O interface 217 receives data from an I/O device 240, such as a remote control or other device operated by a user.

An advantage of using a USB interface between the camera interface 173 and controller 200 is that the camera may be detachable attached from the controller 200.

The controller 200 includes a video codec 201 and a data processor 202. The video codec 201 is responsible for processing video data to be displayed by the display 120 and video data to be transmitted to and received from remote endpoints of the videoconference. In general, the video data can include images (pictures) captured by the camera 170 of the terminal 100, images from remote endpoints in a videoconference, content from a peripheral device, and other visual data. Operation of such a video codec 201 in the context of videoconferencing is well known in the art is not described herein.

The processing device 202 may be a microprocessor responsible for processing data for the videoconferencing unit 110. This data includes data from the camera interface 231, communication data, commands (e.g. from the I/O interface 217), instruction related to a document camera mode function 222 according to the present invention, and optionally a normal mode function 223 (person pick-up mode function), videoconference information, etc. The controller 200 is also coupled to a network interface 214, such as commonly used for a videoconferencing unit, and the network interface 214 couples to a videoconference network known in the art.

The controller 200 controls operation of at least some features of the videoconferencing endpoint 1 using the instructions/functions stored in memory 220. These operational functions include a document camera mode function 222. This operational function 222 is discussed in more detail later, but a general overview of the document camera mode functions 222 is provided here. The document camera mode function 222 allows the videoconferencing unit 110 to switch to a document camera mode when the camera is tilted beyond a predefined tilt threshold. When the videoconferencing unit 110 is in the document camera mode, the videoconferencing unit modifies the images from the camera 170 by at least rotating the images 180 degrees and displays the modified image on the display 120. This rotation is done automatically upon detecting, by a tilt sensor in the tilt mechanism 172, the tilt of the camera beyond a predetermined angular (tilt) threshold. The tilt sensor can be any one of a variety of angular detection mechanisms including an electro-resistive sensors, optical sensors, gyroscopic sensors, mechanical potentiometer-type sensors, piezoelectric sensor, and magnetic detection sensors. The function of the sensor is to produce a signal corresponding to an angle of rotation of the camera relative to a fixed point, such as a horizontal position, or a vertical position at either end of the range of movement for the camera 170.

Illustrated in FIG. 5, the above mentioned tilt threshold is a tilt angle α=t between the start position and the end position of the camera 170 defining a transition between a first tilt range where the video conferencing terminal operates in a normal mode (person pick-up) and a second tilt range where the video conferencing terminal operates in a document camera mode. In this case, the start position represents a position of the camera along its longitudinal axis being parallel to a support surface on with the main body of the display is positioned. Hence, the desktop terminal according to the present invention operates in a person pick-up mode (or video conference mode) when the camera is positioned within a first range between the starting position and the predefined threshold (such as 0 degrees to 25 degrees), and the desktop terminal operates in a document pick-up mode when the camera is position within a second range between the predefined threshold (e.g., 26 degrees, or more steep angle, such as 45 degrees) and the end position (such as 80 degrees or 90 degrees, depending on the maximum pivotable range of the camera).

According to one exemplary embodiment, the predefined tilt threshold is set at approximately 45 degrees relative to the desktop surface (or start position of camera). However, the predefined threshold may be set in the range of 30-90 degrees relative to the desktop surface. Operating with two tilt ranges and a tilt threshold allows for freedom to adjust the camera either in person pick-up mode or document pick-up mode to accommodate for user height differences and document/object size and placement differences. In the document pickup mode, the controller 200 (FIG. 4) performs image processing on the captured image to correct for any keystone effect caused by the camera lens not being coplanar with the document. The controller 200 receives as input an angle of tilt, and the amount of keystone compensation decreases as the camera lens becomes more co-planar with the document.

The terminal 100 includes a tilt sensor in the tilt mechanism 172. The sensor may be optical, magnetic or electronic, or the sensor may be a motion sensor or a rotational sensor, or any other suitable sensor that detections motion or position.

According to one exemplary embodiment of the present invention, the main body 110 or the tilt mechanism 172 includes a sensor. The sensor detects when the camera is tilted beyond the predefined tilt threshold, and sends a control signal to the video conferencing unit 110 via the camera interface 231.

According to another exemplary embodiment of the present invention, the camera includes a motion sensor (e.g. an accelerometer) or a rotation sensor (e.g. a gyroscope). The motion sensor or rotation sensor can detect the exact position (or tilt angle α) of the camera relative to a reference position (e.g. the start position). Hence, the tilt angle α of the camera can be detected and sent to the controller 200 via the camera interface 231 via the interface 173, as shown. According to one exemplary embodiment, an accelerometer is used to detect the camera's 170 tilt angle α, e.g. a LIS302DL 3-axiz MEMS motion sensor may be used. Also, the sensor may include electrical contacts such that when the camera is within a first rotation range of tilt it makes contact with a first electrical contact, thus allowing for an electrical or capacitive detection of position. Alternatively if the camera is tilted to a steeper angle that places the camera in a position to contact a second electrical contact, the presence of the camera in the second range of tilt is detectable by electrical or capacitive detection.

As mentioned above, the desktop terminal according to the present invention operates in a normal (person pick-up or video conference) mode when the camera is positioned within in a first tilt range (between the starting position and the predefined threshold). In the normal mode, the video conferencing unit 110 operates as a traditional video conferencing unit, e.g. receiving audio and video streams from a remote video conferencing device(s) (remote endpoint(s), MCU, etc.) and displaying the video streams on the display 120, and sending audio and video streams to the remote video conferencing device(s), wherein the video stream is the video stream from the camera 170 coded according to appropriate video conference coding standards. When the camera 170 is tilted beyond the predefined tilt threshold the desktop video conference terminal 100 switches to document pick-up mode. In document pick-up mode, the controller 200 enables/loads the document camera mode function 222. The document camera mode function 222 causes the videoconferencing unit 110 to modify the images from the camera 170 prior to sending them to remote video conferencing devices, and to display the modified images on the display 170 of the desktop terminal. Modifications include a rotation of the image so the image may be seen in a consistent matter between all end-point participants, and correction for keystone effects.

According to one exemplary embodiment of the present invention, the controller 200 receives an image from said camera and modifies said received video signal by rotating said image 180 degrees (or a vertical flip). The modified image is sent to the display adapter 215 and to the video codec 201, where the image is coded and sent to one or more remote video conference devices via network interface 214.

The camera 170 may include an infrared-based autofocus feature for an autofocusing operation performed by a focus control mechansim contained in the camera 170, or in the controller 200 (FIG. 4). Automatic focus may be useful if a three-dimensional object is placed underneath the camera 170 while in the document mode. Automatic focus may be performed by sending in an infrared signal which reflects off the object underneath the camera 170 and returns a portion used for determining the distance and focal length for the camera 170. Alternatively, manual focus control may be performed by an operator rotating a lens of the camera, to adjust the focal length of the camera.

In addition to automatic focusing, a zoom operation for the camera 170 may be included, optionally. When in the document camera mode of operation the camera 170 employs object detection (using IR transceiver) and a software-based mechanism for detecting a rectangular shape or trapezoidal shape, since the shape of a document underneath the camera, when oriented at a predetermined angle relative to the document, may not appear as rectangular. The zoom control operation then calculates the amount of zoom required in order to best frame the document. Image detection processing may be performed to detect edges of the document, and fill a larger space of the active part of the image sensor within the camera 170 in order to set the zoom amount of the camera 170. Typically, the zoom is set so that either an entire height of the document or entire width of the document is captured. These are user settable parameters, although a default mode may also be used. According to another exemplary embodiment of the present invention, the received image is further modified by correcting for keystone effects in the received image. The keystone effect is caused by attempting to project an image onto a surface, or attempting to capture an image of an object, at an angle. An image captured by the camera 170 of a rectangular sheet of paper, placed on the desktop in front of the desktop terminal 100, will contain distortions of the paper dimensions, making it look like a trapezoid. In an image captured by the camera 170, the sheet of paper will appear wider at the bottom than at the top. The distortions of the paper dimension will depend on the tilt position of the camera. The distance from the desktop to the camera, the zoom factor, field of view of the camera are all known parameters. In the embodiment where the camera includes a motion sensor or a rotation sensor, the exact tilt position of the camera is also a known parameter. Based on one or more of these known parameters, the control unit applies keystone correction on the received image to correct distortions in the image.

The image modification is performed by data processor 202 in the controller 200, may be a FPGA, PLA, or other programmable or fixed logic . . . etc.

According to one embodiment of the invention, the camera 170 includes the data processor 202, which performs said image modification.

According to another exemplary embodiment of the present invention, the modified image is displayed on the display of the desktop terminal 100.

According to one embodiment, the modified image is displayed as a full screen image. For example, the video conference unit switches to full screen self-view when the terminal switches to document camera mode.

According to another embodiment, the modified image is displayed as a picture in picture covering only parts of the display surface of display 170.

In another aspect, the modified image is displayed as a full screen image, while one or more images from one or more remote conference devices are displayed as picture in picture covering only parts of the display surface of display 170.

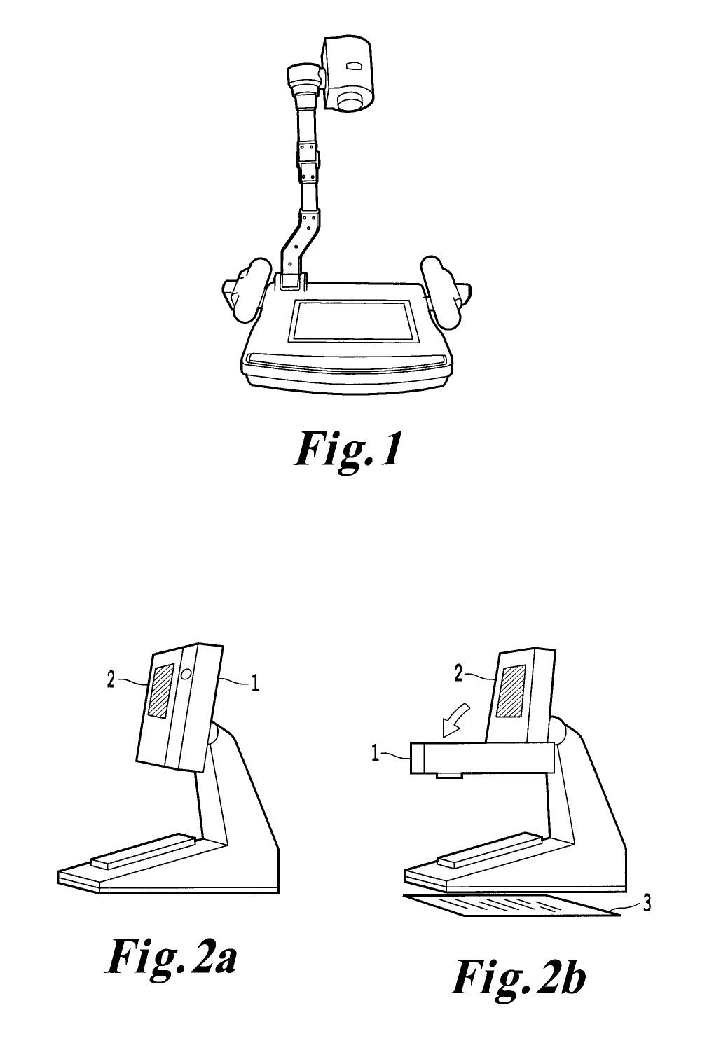

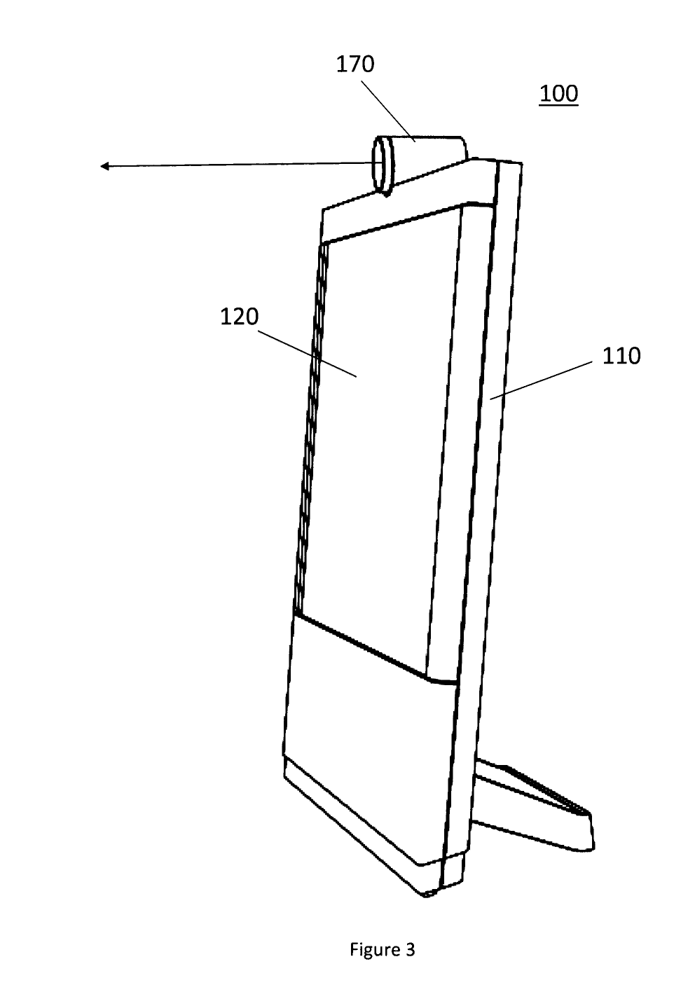

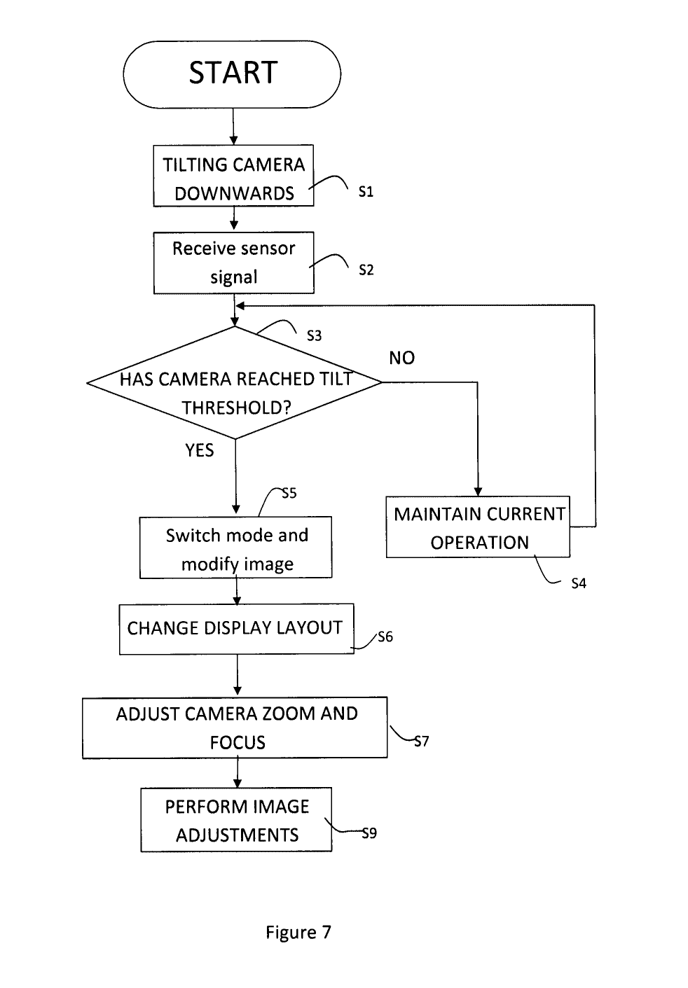

FIG. 7 is a flowchart illustrating the principle of a method for using a desktop terminal as a document camera according to one exemplary embodiment of the present invention. The method starts where, as shown in FIG. 1, the camera 170 is positioned to face forward (optical axis of the camera 170 is substantially horizontal) in order to pick up a person in front of the terminal 100.

From this position, the camera 170 is tilted downward manually by the user in step S1, such that the optical axis of the camera is tilted from a substantially horizontal plane towards a vertical plane.

In Step S2, the Controller 200 receives sensor signals from a tilt sensor.

According to one exemplary embodiment, a tilt sensor sends a signal (or the sensor signal changes) when the camera is tilted beyond a predefined tilt threshold. For example, the desktop terminal 100 may include an optical sensor attached to the terminal body close to the camera tilt mechanism. Further, the camera 170 or the tilting mechanism includes an activation part (e.g. protruding part or flap) that covers the optical sensor when the camera is within the first tilt range. When the camera is tilted beyond the predefined tilt threshold, the activation part exposes the optical sensor, which in turn changes the sensor's output signal.

According to another exemplary embodiment, the degree of turning is detected by a motion sensor or a rotation sensor in the camera 170, and a sensor signal indicating the current tilt angle of the camera is transmitted to the Controller 200. Motion sensors and rotation sensor often have high resolutions which give a very accurate estimate of the actual tilt angle of the camera.

The controller 200 determines whether the camera 170 has reached the tilt threshold or not, in accordance with the sensor signal (S3). If the degree of tilting is less than the tilt threshold, it is determined that the camera 170 is within the first tilt range and that the video conferencing unit 110 should maintain current operation, hence maintain standard video conferencing (normal) mode (S4).

If the degree of tilting reaches the tilt threshold value, it is determined (S3) that the camera 170 is within the second tilt range and that the video conferencing unit 110 should switch to document camera mode and modify the image (S5). In the document camera mode, the controller 200 modifies the image received from the camera 170 (via the video input module 216), and in addition to sending the modified image to the video codec 201, the modified image is displayed on the display 120.

According to one exemplary embodiment, the controller modifies the image by rotating the received image by 180 degrees. The controller also changes the display layout (S6) of the endpoint, such that instead of displaying the remote site, the rotated image is displayed as a full screen image on the display 120. This allows the local and remote user to view the depicted document or object in the correct orientation. Displaying the depicted document or object to the local user gives the local user a visual feedback on what the remote viewer is actually seeing, and is helpful when the local user wishes to point at certain parts of a document, introduce new documents, etc.

In an embodiment, the display layout is changed (S6) such that an image of one or more remote participants is displayed on the display 120 together with the modified image. In one embodiment, the modified image is displayed as a full screen image, while the one or more remote users are displayed as one or more smaller images, traditionally referred to as picture-in-picture. In another embodiment, one or more of the remote users are displayed as a full screen image, while the modified image is displayed as a smaller image, traditionally referred to as picture-in-picture. The camera's zoom and focus are set based on the rotation angle (S7).

According to another exemplary embodiment, the controller also modifies the received image by correcting keystone effects in the received image (S9).

The procedure illustrated in FIG. 7 is according to one embodiment implemented by controller 200. A starting step S1 is shown, but it will be appreciated that controller 200 performs many operations and therefore a starting step should be understood to be an entry point into a subroutine, such as a subroutine used for changing operation mode.

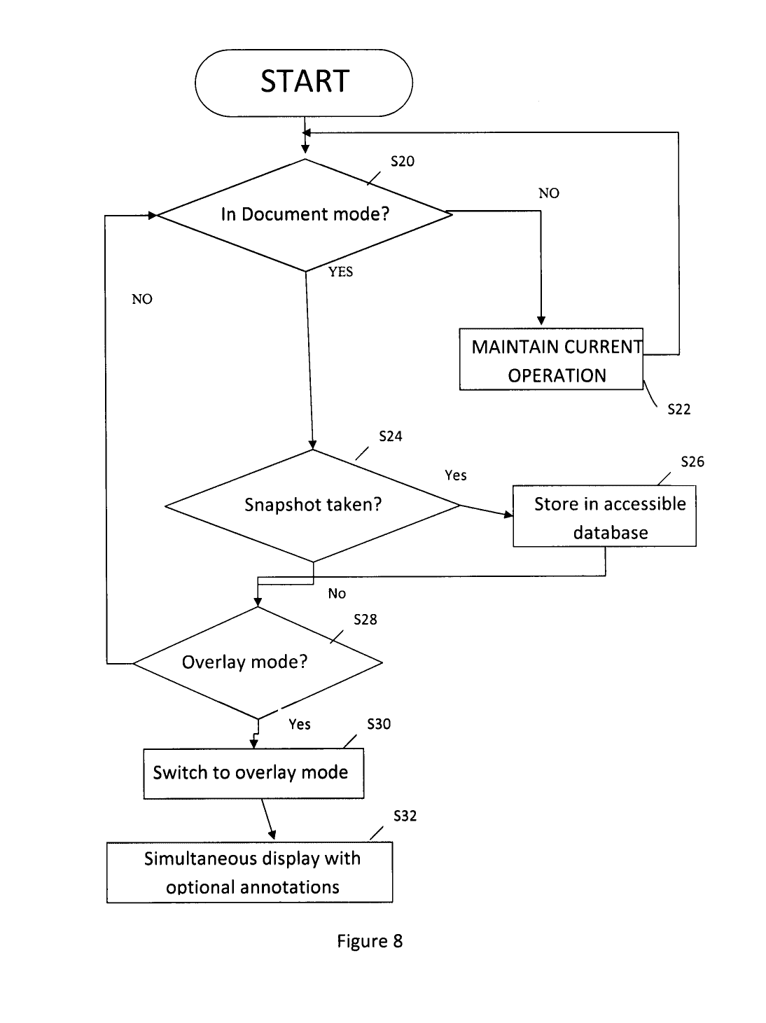

In addition to the processing described in FIG. 7, additional processing may be performed as now discussed with regard to FIG. 8. In FIG. 8, a process begins with a query in step S20, determining whether the system is in the document mode of operation. If the response to the inquiry is negative, the process proceeds to step S22 where current operations are continued and the process returns to step S20. If the response to the inquiry in step S20 is affirmative, the process proceeds to step S24, where an inquiry is made regarding whether a snapshot is taken. A snapshot may be performed by pressing a physical button on the endpoint, keyboard of a computer connected to the endpoint, or a soft key/menu option in a graphical user interface for the endpoint that captures the image (snapshot) of the video stream, or via another input mechanism. Once the snapshot of the video stream is taken, the data processor 202 (FIG. 4) creates a digitized image of the document or object captured by the camera. The image is formatted in any one of a predetermined image format such as JPEG, RAW, TIFF, GIF, etc., and stored locally such as in the local disk 220 (FIG. 4) or on a remote storage device connectable through the network interface 214, for example. Other local memories may be used such as peripheral devices connected by way of a USB interface, for example.

When stored either internally, locally, or over a network, the snapshot image may be reproduced and displayed on a screen 120, or on another monitor such as a laptop device connectable through the IO device 240. One example of a laptop or other computer device that is connected locally is shown as computer 1500 which includes a display screen of its own and a keyboard interface. The interface may include any one of a variety of connectors including USB 2.0, or FIREWIRE, for example. The snapshot of the image is presentable not only on the endpoint 110, but also remotely to a remote endpoint, for example. This way images that are captured of the video screen or an object may then be available for display locally or remotely.

Returning to FIG. 8, if the inquiry in step S24 results in an affirmative response, the process proceeds to step S26 where the image is stored in an accessible database, such as the storage devices discussed above. The process then proceeds to step S28, where an inquiry is made regarding whether an overlay mode of operation has been selected. If the response to the inquiry in step S20 is negative, the process returns to step S20. On the other hand, if the response to the inquiry in step S28 if affirmative, the process proceeds to step S30 where the overlay mode of operation is performed (as will be discussed below) and the process then proceeds to step S32.

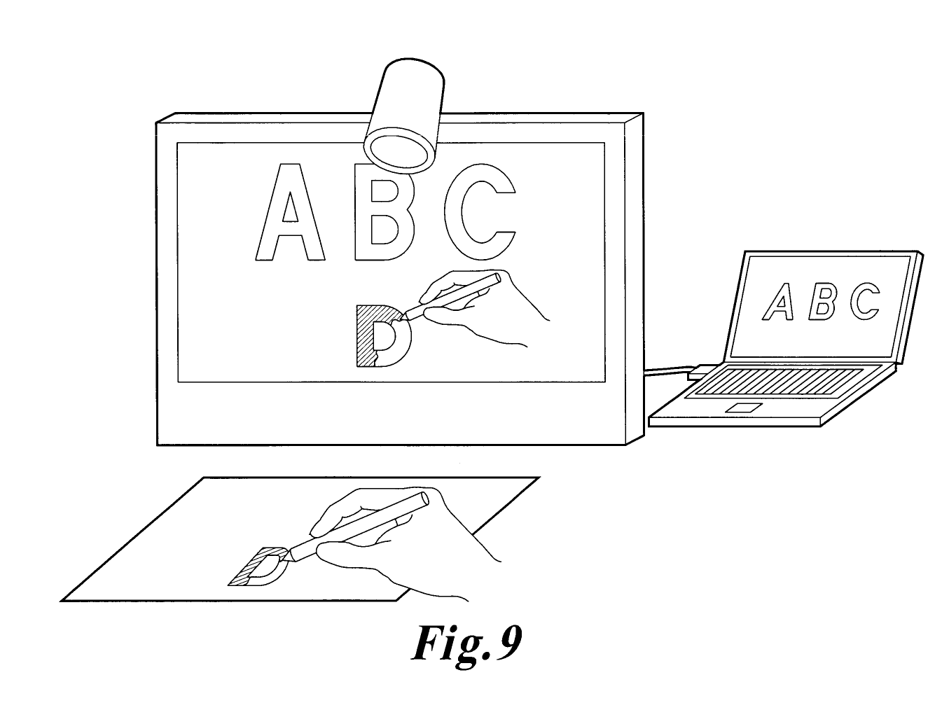

In step S32 simultaneous display of an image or video captured by the camera 170 is displayed in the foreground of a background image captured from another device, such as video from a remote endpoint operating in normal mode or document mode or a remote or local computer 1500, or previously stored. In the example of FIG. 9, the camera 170 is disposed on the main body of the endpoint 110. The display 120 displays an image provided by a locally connected computer 1500. The computer may be also remotely connected (e.g. using the H.239 ITU-T recommendation), and content provided by the computer is provided for display on the display 120 of the endpoint 110. A document 1211 provided below the camera 170, is captured in the overlay mode (which is user selectable) either by actuating a physical button, direct auto detection of a connection with the computer 1500, or through a soft key/menu option presented on one of the computer 1500, endpoint 110 or camera 170. An image of a subject (in this case a paper 1211 with a person drawing the letter “D”) is captured (either static video image or dynamic video image, which shows movement) by the camera 170. The image captured by the camera 170 is overlaid on the image presented from the computer 1500 on the display 120 of the endpoint 110. The remote site also (optionally) simultaneously displays the foreground and background image, as an overlay.

For example, a particular site, namely site A, sends “duo video” to another endpoint (for example site B, or operates in a document mode and hence sends an image of a document or object in a main video to site B), for simultaneous display. In particular, at site B, the operator may tilt the camera 170 into the document mode of operation so that images of a document within the viewable range of the camera 170 may then be captured. Then the endpoints at site A and site B exchange signals, in a handshaking operation confirming both are operating in the document mode, and both of the endpoints then switch to an overlay mode. As an alternative, at one of the sites, the operator triggers the selection of the overlay mode by pushing a button or making a soft key selection via a GUI for example.

Once in the overlay mode, video from both sites are displayed simultaneously (as shown in screen 120) where video from the local camera (or both the local camera and the remote video) are semi-transparent. The amount of transparency is user selectable. For example at site B, both the video from site A (either “duo video” or main video) and the video from the local site (site B) is displayed on the local display of site B. When site B has a paper 1211 on the desk underneath the camera 170, and a user starts drawing on it, both sites A and B can see the annotations being made at site B to the original document or PowerPoint presentation originally input from site A. Thus, when site A and B are both in the document mode, they will in reality present to a user a collaborative drawing as a common electronic document. This allows for enhanced collaboration between users of both endpoints by sharing media other than merely video of the video conference participants. Moreover, document data or other object data (the camera 170 need not capture only documents) presents simultaneous display provided from both endpoints (site A and site B) so that a collaboration drawing may be generated (via merging images from both streams into one image). A snapshot of the collaboration drawing can be made and stored on any of the local storage devices or network storage devices, for example.

1. A desktop terminal for video conferencing comprising:
a display;
a camera with a pivotable range of motion;
a sensor that produces an output corresponding to an amount of tilt of said camera with respect to a predetermined optical plane, said terminal being configured to
operate in a video conference mode when said camera is positioned in a first pivot range, and operate in a document camera mode when said camera is positioned within a second pivot range;
a video conferencing unit configured to code video from said camera and decode audio visual media and to transmit/receive coded audio visual media to/from remote video conferencing terminals over a network; and
a controller configured to, switch said terminal from video conference mode to said document camera mode when said sensor detects said camera in said second pivot range, and when operating in the document camera mode,
receive a video signal from said camera,
modify said received video signal by at least rotating said video image 180 degrees,
output a modified video signal to said video conferencing unit for display as a rotated video image on said display, and
transmit a coded version of said rotated video image to at least one remote terminal.

2. A terminal according to claim 1, wherein said video conference unit is configured to display at least a full screen image of said rotated video image when operating in the document camera mode.

3. A terminal according to claim 1, wherein:
the controller, when operating in the document camera mode, is further configured to correct perspective projection distortions in the video signal, including a keystone effect caused by said camera not being positioned perpendicular to a document captured by said camera.

4. A terminal according to claim 1, wherein:
the first pivot range and the second pivot range are separated by an operation mode threshold, and that said sensor includes at least one of a motion sensor and a rotation sensor that detects a pivot position of said camera.

5. A terminal according to claim 3, wherein the correction of the perspective projection distortions is performed using known parameters of a distance between a desktop and the camera, a field of view of the camera, amount of zoom, and a pivot position of the camera.

6. A terminal according to claim 1, wherein:
the first pivot range and the second pivot range are separated by an operation mode threshold, and said sensor is further configured to detect and output a control signal when the camera crosses the operation mode threshold.

7. A terminal according to claim 1, wherein the first pivot range and the second pivot range are of equal size.

8. A terminal according to claim 4, wherein the at least one of a motion sensor and rotation sensor includes one of an optical sensor, a mechanical sensor, an electrical sensor, a magnetic sensor and a piezoelectric sensor.

9. A terminal according to claim 1, wherein:
when the terminal operates in the document camera mode the video conference unit is configured to instruct the camera to zoom in to a predefined zoom position.

10. A terminal according to claim 1, wherein:
said camera includes one of a mechanical zoom and a digital zoom, and when the terminal operates in a document camera mode the computational unit is configured to instruct the camera to zoom in to a predefined zoom position.

11. A terminal according to claim 3, wherein said terminal comprises a user interface allowing a user to adjust a zoom position of said camera.

12. A terminal according to claim 1, wherein:
said camera includes at least one of a mechanical focus and a digital focus, and when the terminal operates in a document camera mode the computational unit is configured to instruct the camera to adjust the focus to a predefined distance.

13. A terminal according to claim 1, wherein:
said controller is configured to switch to an overlay mode in response to user input, and
simultaneously display an image from an external device and the rotated video image, said rotated video image overlapping at least a portion of said image from the external device.

14. A terminal according to claim 1, wherein:
said controller is configured to perform object detection when in the document camera mode and adjust an amount of zoom for capturing the object and displaying an image of the object on a majority of a display area of said display.

15. A method for changing a video conferencing terminal mode of operation, comprising:
positioning a camera in a first pivot range when operating in a video conference mode of operation, said camera being pivotally associated with a video conferencing terminal;
operating in a document camera mode of operation when said camera is positioned within a second pivot range;
detecting with a sensor a change from pivot position of said camera from said first pivot range to said second pivot range;
switching said terminal from video conference mode to said document camera mode when said sensor detects said camera changing from the first pivot range to said second pivot range,
coding and decoding with a video conferencing unit audio visual media; and
transmit and receiving coded audio visual media to/from remote video conferencing terminals over a network, wherein
when operating in document camera mode, receiving at a video conferencing unit a video signal from said camera, modifying said video signal by at least rotating an image described by said video signal 180 degrees, and outputting a modified video signal to said video conferencing unit for displaying a rotated video image on a display and transmitting a coded version of said rotated video image to at least one remote terminal.

16. The method of claim 15, further comprising:
displaying at least a full screen image of said rotated video image when operating in the document camera mode.

17. The method of claim 15, wherein:
said operating step includes correcting perspective projection distortions in the video signal, including a keystone effect caused by said camera not being positioned perpendicular to a document captured by said camera.

18. The method of claim 15, further comprising:
detecting a pivot position of the camera with at least one of a motion sensor and a rotation sensor, said detecting step including recognizing a detected position as being in one of the first pivot range and the second pivot range and being separated by an operation mode threshold.

19. The method of claim 15, further comprising:
switching to an overlay mode in response to user input;
receiving an image from another device and displaying said image on said display; and
simultaneously displaying on the display said image and the rotated video image.

20. The method of claim 19, wherein:
said simultaneously displaying step includes displaying said rotated video image as annotations on said image from the another device, said rotated video image overlapping at least a portion of said image from the external device.
